(19) United States
(12) Patent Application Publication
(10) Pub. No.: US 2026/0143420 A1
(43) Pub. Date: May 21, 2026

(54) CONFIGURABLE WIRELESS COMMUNICATION SERVICES

(71) Applicant: Charter Communications Operating, LLC, St. Louis, MO (US)

(72) Inventor: Deh-Min Richard Wu, Centennial, CO (US)

(73) Assignee: Charter Communications Operating, LLC, St. Louis, MO (US)

(21) Appl. No.: 19/449,586

(22) Filed: Jan. 15, 2026

Related U.S. Application Data
(63) Continuation of application No. 18/354,052, filed on Jul. 18, 2023.

(51) Int. Cl. H04W 48/18; H04W 60/00

(52) U.S. Cl. CPC H04W 48/18; H04W 60/00

(57) ABSTRACT

In a wireless communication system in which a wireless device receives communication services from a home network having a home network core, the wireless device and/or the home network core prioritizes connection to a visiting network over the home network in a situation in which connection to either the home network or the visiting network is available. The wireless device and/or the home network core may be configured with a priority list that prioritizes the visiting network over the home network based on one or more of the communication services requested by the wireless device, the type of communication device, and the type of network subscription of the user of the wireless device. The home network core may transmit a message to the wireless device via the visiting network confirming the communication services provided to the wireless device, thereby hiding the visiting network from the user.

### CROSS-REFERENCE TO RELATED APPLICATIONS

This is a continuation of co-pending application Ser. No. 18/354,052, filed on Jul. 18, 2023, the teachings of which are incorporated herein by reference in their entirety.

### BACKGROUND

### Field of the Disclosure

The present disclosure relates to wireless communications and, more specifically but not exclusively, to the provision of wireless communication services by wireless service providers to subscribers and non-subscribers.

### Description of the Related Art

This section introduces aspects that may help facilitate a better understanding of the disclosure. Accordingly, the statements of this section are to be read in this light and are not to be understood as admissions about what is prior art or what is not prior art.

In conventional wireless communications, a cell phone user subscribes to a wireless service provider. Whenever the cell phone is located within range of a base station of that subscribed service provider, the cell phone will connect to that base station such that wireless communications to and from the cell phone are provided by the subscribed service provider, even if signals from a base station of another service provider to which the user is not a subscriber are better (e.g., higher signal strength and/or higher signal quality) than the signals from the base station of the subscribed service provider.

If the subscribed service provider has an appropriate service agreement with a non-subscribed service provider, then the cell phone of the subscribing user is allowed to connect to a base station of the non-subscribed service provider, but only when no base station of the subscribed service provider is available. In that case, when communications between the cell phone and the non-subscribed base station are initiated, the core network of the non-subscribed service provider will communicate (via a backhaul) with the core network of the subscribed service provider to confirm that the non-subscribed service provider has permission to provide wireless communication services to the cell phone via the non-subscribed base station.

### SUMMARY

Embodiments of the present disclosure enable wireless communication services with wireless user equipment (UE), such as, but not limited to, a cell phone, to be provided by a base station of a non-subscribed service provider (referred to herein as a visiting public land mobile network or VPLMN for short) even when a base station of the cell phone's subscribed service provider (referred to herein as the home public land mobile network or HPLMN for short) is available to provide those wireless communication services.

### BRIEF DESCRIPTION OF THE DRAWINGS

Embodiments of the disclosure will become more fully apparent from the following detailed description, the appended claims, and the accompanying drawings in which like reference numerals identify similar or identical elements.

FIG. 1 is a simplified block diagram representing a situation in which a UE is located within both (i) the coverage area of a base station of its home network and (ii) the coverage area of a base station of a non-home or visiting network;

FIG. 2 is a signal flow diagram representing a scenario in which the UE of FIG. 1 connects to the visiting network instead of its home network;

FIG. 3 is a simplified block diagram representing a situation in which a UE is located within both the coverage area of a base station of a first visiting network and the coverage area of a base station of a second visiting network, but not within the coverage area of any base station of the UE's home network;

FIG. 4 is a signal flow diagram representing a scenario in which the UE of FIG. 3 connects to the second visiting network instead of the first visiting network; and

FIG. 5 is a simplified hardware block diagram of an example component that can be used to implement the UEs and the network cores of FIGS. 1-4.

### DETAILED DESCRIPTION

Detailed illustrative embodiments of the present disclosure are disclosed herein. However, specific structural and functional details disclosed herein are merely representative for purposes of describing example embodiments of the present disclosure. The present disclosure may be embodied in many alternate forms and should not be construed as limited to only the embodiments set forth herein. Further, the terminology used herein is for the purpose of describing particular embodiments only and is not intended to be limiting of example embodiments of the disclosure.

As used herein, the singular forms “a,” “an,” and “the,” are intended to include the plural forms as well, unless the context clearly indicates otherwise. It further will be understood that the terms “comprises,” “comprising,” “contains,” “containing,” “includes,” and/or “including,” specify the presence of stated features, steps, or components, but do not preclude the presence or addition of one or more other features, steps, or components. It also should be noted that in some alternative implementations, the functions/acts noted may occur out of the order noted in the figures. For example, two figures shown in succession may in fact be executed substantially concurrently or may sometimes be executed in the reverse order, depending upon the functions/acts involved.

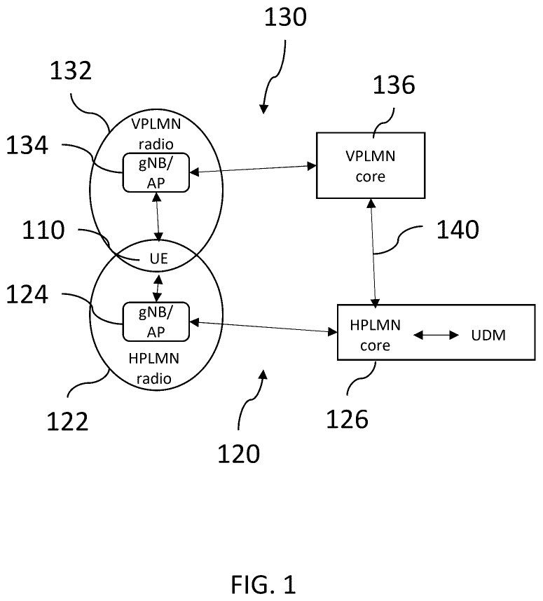

FIG. 1 is a simplified block diagram representing a situation in which a UE 110 is located within both (i) the coverage area 122 of a base station 124 of its home network (i.e., HPLMN) 120 and (ii) the coverage area 132 of a base station 134 of a non-home or visiting network (i.e., VPLMN) 130 with which the HPLMN network 120 has a service agreement. Depending on the situation, each base station 124/134 may independently be either a gNodeB (gNB) of a 3G/4G/5G cellular network or an access point (AP) of a wireless local area network (LAN).

According to the prior art, whenever a conventional UE is in the situation of FIG. 1, the UE will always connect to the HPLMN base station such that wireless communication services will be provided to the UE by the HPLMN network. According to embodiments of the present disclosure, however, the UE 110 and the HPLMN core network 126 may be configured to enable the UE 110 to connect to the VPLMN base station 134 instead of the HPLMN base station 124 such that wireless communication services for the UE 110 are provided by the VPLMN network 130 instead of the HPLMN network 120 even though the HPLMN network 120 is available to the UE 110.

In some embodiments, the UE 110 will connect to the VPLMN base station 134 instead of the HPLMN base station 124 if any one of the following conditions are met:
The received signal strength from the VPLMN base station 134 is greater than the received signal strength from the HPLMN base station 124;
The signal quality (e.g., bit error rate, latency, bandwidth) from the VPLMN base station 134 is greater than the signal quality from the HPLMN base station 124; and
The UE 110 is programmed with a priority list in which connection to the VPLMN network 130 has priority over connection to the HPLMN network 120 for certain types of communication services (e.g., telephony, file/data transfer, video streaming).

In addition or alternatively, the HPLMN core 126 may be programmed (e.g., in a unified data management (UDM) module) with a policy that prioritizes connection to the VPLMN network 130 over connection to the HPLMN network 120 under certain specified circumstances, such as the type of wireless communication service requested by the UE 110 and the signal strength and/or quality. For example, the programmed policy may be that the HPLMN network 120 will be selected for conventional telephony service, but the VPLMN network 130 will be selected for higher-bandwidth or higher-quality services like data/file transfer or video communications, or vice versa. Another example, the programmed policy may be that specific types of communication devices 110 and/or some selected subscribers and/or non-subscribers are prioritized to the VPLMN network 130.

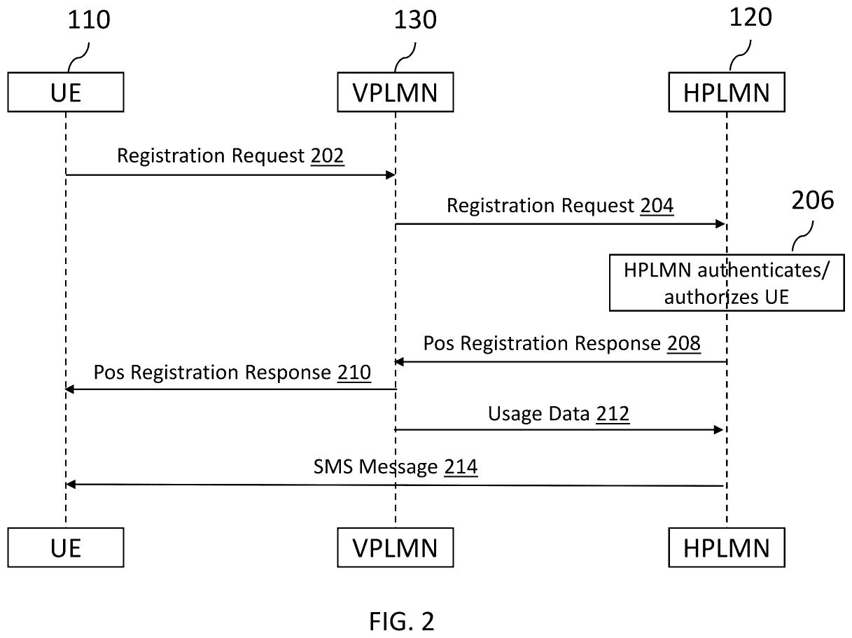

FIG. 2 is a signal flow diagram representing a scenario in which the UE 110 of FIG. 1 connects to the VPLMN network 130 instead of its HPLMN network 120. In this scenario, the following conditions apply:
The UE 110 subscribes to the HPLMN network 120;
The UE 110 is located within the coverage areas 122 and 132 of both the HPLMN network 120 and the VPLMN network 130 as in FIG. 1;
The HPLMN network 120 and the VPLMN network 130 have a suitable service agreement that allows the VPLMN network 130 to provide wireless communication services to the UE 110 in certain situations, one of which may currently exist; and
The UE 110 is programmed to prioritize the VPLMN network 130 over the HPLMN network 120 in those certain situations and/or the signal from the VPLMN network 130 is stronger and/or of higher quality than the signal from the HPLMN network 120.

In step 202 of FIG. 2, the UE 110 transmits a registration request to the VPLMN network 130 identifying itself, the type(s) of service(s) requested (e.g., telephony, data/file transfer, video streaming, etc.), and the quality of service (QoS) needed. Recognizing that the UE 110 is a subscriber of the HPLMN network 120, in step 204, the VPLMN network 130 (actually, the VPLMN core 136 of FIG. 1) forwards a version of the registration request to the HPLMN network 120 (actually, the HPLMN core 126 of FIG. 1) via the backhaul 140 of FIG. 1, where that registration request also identifies the VPLMN network 130.

In step 206, the HPLMN core 126 of the HPLMN network 120 accesses the policies in its UDM module (see FIG. 1) to determine that the current situation is appropriate for the VPLMN network 130 to provide the requested communication service to the UE 110. As such, in step 208, the HPLMN core 126 of the HPLMN network 120 transmits a positive registration response to the VPLMN core 136 of the VPLMN network 130, and, in step 210, the VPLMN network 130 (actually, the VPLMN base station 134 of FIG. 1) transmits a positive registration response to the UE 110.

In step 212, the VPLMN network 130 sends usage data associated with the requested communications to the HPLMN network 120. In step 214, the HPLMN network 120 transmits an SMS message to the UE 110 via the VPLMN network 130 acknowledging the communication services being provided to the UE 110. To the user of the UE 110, the SMS message appears to come from the user's HPLMN network 120 instead of the VPLMN network 130, thereby hiding the fact from the user that the received communication services are actually being provided by the VPLMN network 130 instead of the user's own HPLMN network 120.

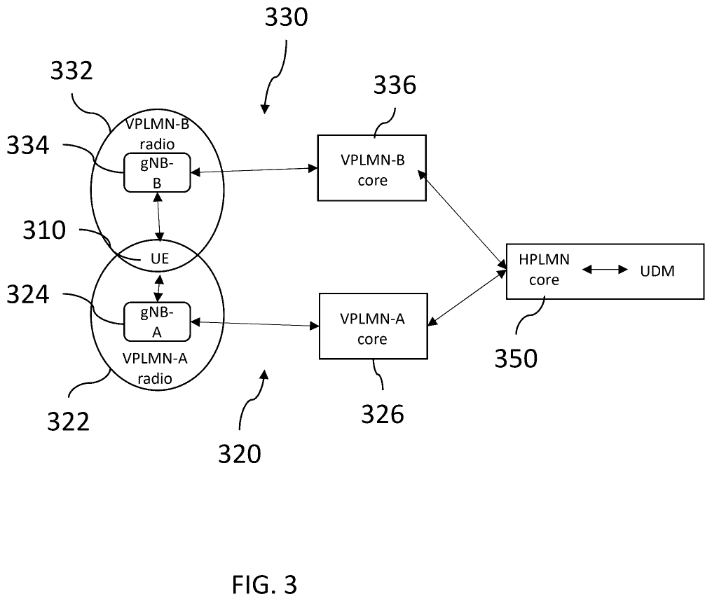

FIG. 3 is a simplified block diagram representing a situation in which a UE 310 is located within both the coverage area 322 of a base station 324 of a first visiting network (i.e., VPLMN-A) 320 and the coverage area 332 of a base station 334 of a second visiting network (i.e., VPLMN-B) 330, but not within the coverage area of any base station of the UE's home network (i.e., HPLMN), where the HPLMN network has service agreements with both of the VPLMN-A and VPLMN-B networks 320 and 330.

According to the prior art, whenever a conventional UE is in the situation of FIG. 3, the UE will always connect to the VLPMN base station having the strongest received signal at the UE. According to embodiments of the present disclosure, however, the UE 310 and the HPLMN network core 350 may be configured to enable the UE 310 to connect to either the VPLMN-A base station 324 or the VPLMN-B base station 334 depending on the situation.

In some embodiments, the UE 310 will connect to the VPLMN-B base station 334 even if the received signal strength from the VPLMN-A base station 324 is greater than the received signal strength from the VPLMN-B base station 334, if any one of the following conditions are met:
The signal quality from the VPLMN-B base station 334 is greater than the signal quality from the VPLMN-A base station 324; and
The UE 310 is programmed with a priority list in which connection to the VPLMN-B network 330 has priority over connection to the VPLMN-A network 320.

In addition or alternatively, the HPLMN core 350 may be programmed (e.g., in a UDM module) with a policy that prioritizes connection to the VPLMN-B network 330 over connection to the VPLMN-A network 320 under certain specified circumstances. For example, the VPLMN-B network 330 may be prioritized over the VPLMN-A network 320 for certain services that have lower fees under the two different service agreements with the HPLMN network.

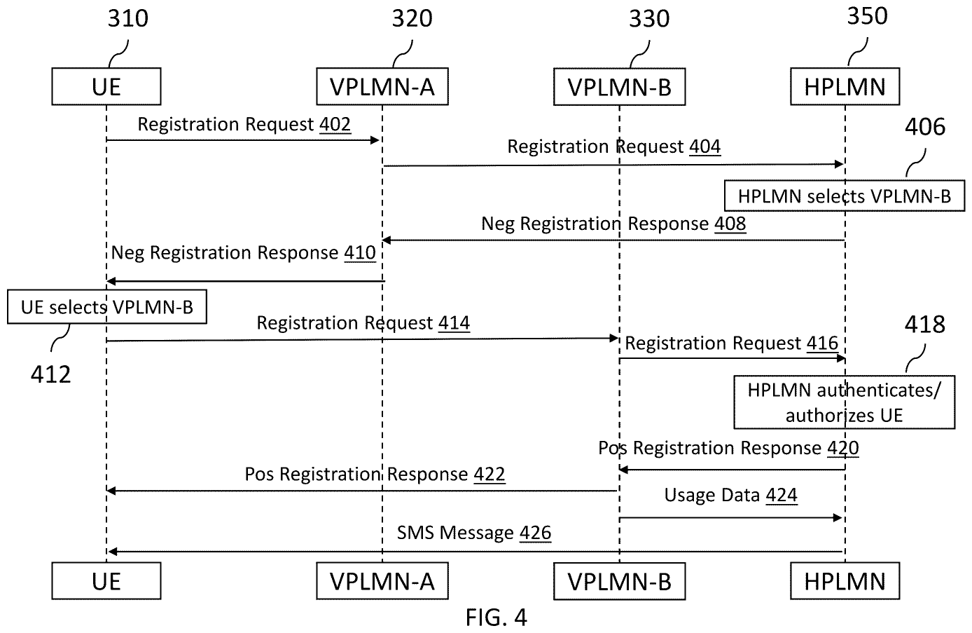

FIG. 4 is a signal flow diagram representing a scenario in which the UE 310 of FIG. 3 connects to the VPLMN-B network 330 instead of the VPLMN-A network 320. In this scenario, the following conditions apply:
The UE 310 subscribes to the HPLMN network 350;
The UE 310 is located within the coverage areas 322 and 332 of both the VPLMN-A network 320 and the VPLMN-B network 330 as in FIG. 3, but not within the coverage area of any base station of the UE's HPLMN network 350;
The received signal strength from the VPLMN-A base station 324 is greater than the received signal strength from the VPLMN-B base station 334;
The HPLMN network 350 has suitable service agreements with both the VPLMN-A network 320 and the VPLMN-B network 330 that allow those VPLMN networks to provide wireless communication services to the UE 310 in certain situations, one of which may currently exist;
The HPLMN network core 350 is programmed to prioritize the VPLMN network-B 330 over the VPLMN-A network 320 in those certain situations and/or the signal from the VPLMN-B base station 334 is of higher quality than the signal from the VPLMN-A base station 324; and
The UE 310 is programmed with a priority list that prioritizes the VPLMN-A network 320 over the VPLMN-B network 330.

In step 402 of FIG. 4, the UE 310 transmits a registration request to the VPLMN-A network 320 identifying itself, the type(s) of service(s) requested (e.g., telephony, data/file transfer, video streaming, etc.), and the quality of service (QoS) needed. Recognizing that the UE 310 is a subscriber of the HPLMN network 350, in step 404, the VPLMN-A network 320 (actually, the VPLMN-A core 326 of FIG. 3) forwards a version of the registration request to the HPLMN network core 350, where that registration request also identifies the VPLMN-A network 320.

In step 406, the HPLMN core 350 accesses the policies in its UDM module (see FIG. 3) to determine that the current situation is appropriate for the VPLMN-B network 330, and not the VPLMN-A network 320, to provide the requested communication services to the UE 310. As such, in step 408, the HPLMN core 350 transmits a negative registration response to the VPLMN-A core 326 of the VPLMN-A network 320, and, in step 410, the VPLMN-A network 320 (actually, the VPLMN-A base station 324 of FIG. 3) transmits a negative registration response to the UE 310.

In step 412, the UE 310 determines that the VPLMN-B network 330 is the next PLMN network on its priority list, and, in step 414, the UE 310 transmits a registration request to the VPLMN-B network 330. Recognizing that the UE 310 is a subscriber of the HPLMN network, in step 416, the VPLMN-B network 330 (actually, the VPLMN-B core 336 of FIG. 3) forwards a version of the registration request to the HPLMN core 350, where that registration request also identifies the VPLMN-B network 330.

In step 418, the HPLMN core 350 accesses the policies in its UDM module (see FIG. 3) to determine that the current situation is appropriate for the VPLMN-B network 330 to provide the requested communication services to the UE 310. As such, in step 420, the HPLMN core 350 transmits a positive registration response to the VPLMN-B core 336 of the VPLMN-B network 330, and, in step 422, the VPLMN-B network 330 (actually, the VPLMN-B base station 334 of FIG. 3) transmits a positive registration response to the UE 310.

In step 424, the VPLMN-B network 330 sends usage data associated with the requested communications to the HPLMN core 350. In step 426, the HPLMN core 350 transmits an SMS message to the UE 310 via the VPLMN-B network 330 acknowledging the communications services being provided to the UE 310. To the user of the UE 310, the SMS message appears to come from user's HPLMN network instead of the VPLMN-B network 330, thereby hiding the fact from the user that the communication services are actually being provided by the VPLMN-B network 330 instead of the user's own HPLMN network.

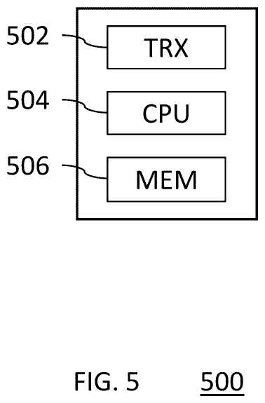

FIG. 5 is a simplified hardware block diagram of an example component 500 that can be used to implement the UEs 110 and 310 of FIGS. 1-4. As shown in FIG. 5, the component 500 includes (i) communication hardware (e.g., wireless, wireline, and/or optical transceivers (TRX)) 502 that supports communications with other components, (ii) a processor (e.g., CPU microprocessor) 504 that controls the operations of the component 500, and (iii) a memory (e.g., RAM, ROM) 506 that stores code executed by the processor 504 and/or data generated and/or received by the component 500. Note that the network cores of FIGS. 1-4 may be implemented using analogous configurations of communication hardware, processors, and memories.

In certain embodiments of the present disclosure, a wireless device comprises communication hardware and a processor configured to control the communication hardware such that the wireless device is configured to receive communication services from a home network; the wireless device is configured to prioritize connection to a visiting network over the home network; and the wireless device is configured to connect to the visiting network instead of the home network in a situation in which connection to either the home network or the visiting network is available.

In at least some of the above embodiments, the wireless device is configured to be programmed with a priority list in which the visiting network is prioritized over the home network.

In at least some of the above embodiments, the priority list prioritizes the visiting network over the home network for a first set of communication services; and the priority list prioritizes the home network over the visiting network for a second set of communication services different from the first set.

In at least some of the above embodiments, the wireless device is configured to (i) transmit a connection request to the visiting network identifying the wireless device and a set of desired communication services, (ii) receive a positive or negative connection response from the visiting network, and (iii) communicate with the visiting network after receiving a positive connection request.

In certain other embodiments of the present disclosure, a home network core comprises communication hardware and a processor configured to control the communication hardware such that the home network core is configured to provide communication services to a wireless device; the home network core is configured with a policy that prioritizes connection of the wireless device to a visiting network having a service agreement with the home network; and the home network core is configured to allow the wireless device to connect to the visiting network instead of the home network in a situation in which connection to either the home network or the visiting network is available.

In at least some of the above embodiments, the home network core is configured to be programmed with a priority list in which the visiting network is prioritized over the home network.

In at least some of the above embodiments, the priority list prioritizes the visiting network over the home network for a first set of communication services; and the priority list prioritizes the home network over the visiting network for a second set of communication services different from the first set.

In at least some of the above embodiments, the home network core is configured to (i) receive a connection request from the visiting network identifying the wireless device and a set of desired communication services and (ii) transmit a positive or negative connection response to the visiting network.

In at least some of the above embodiments, the home network core is configured to prioritize either the visiting network or the home network based on at least one of (a) the wireless device being a particular type of communication device and (b) a user of the wireless device having a particular type of subscription to the home network.

In at least some of the above embodiments, the home network core is configured to transmit a message to the wireless device via the visiting network confirming the communication services provided to the wireless device.

The use of figure numbers and/or figure reference labels in the claims is intended to identify one or more possible embodiments of the claimed subject matter in order to facilitate the interpretation of the claims. Such use is not to be construed as necessarily limiting the scope of those claims to the embodiments shown in the corresponding figures.

Although the elements in the following method claims, if any, are recited in a particular sequence with corresponding labeling, unless the claim recitations otherwise imply a particular sequence for implementing some or all of those elements, those elements are not necessarily intended to be limited to being implemented in that particular sequence. Likewise, additional steps may be included in such methods, and certain steps may be omitted or combined, in methods consistent with various embodiments of the disclosure.

Reference herein to “one embodiment” or “an embodiment” means that a particular feature, structure, or characteristic described in connection with the embodiment can be included in at least one embodiment of the disclosure. The appearances of the phrase “in one embodiment” in various places in the specification are not necessarily all referring to the same embodiment, nor are separate or alternative embodiments necessarily mutually exclusive of other embodiments. The same applies to the term “implementation.”

Unless otherwise specified herein, the use of the ordinal adjectives “first,” “second,” “third,” etc., to refer to an object of a plurality of like objects merely indicates that different instances of such like objects are being referred to, and is not intended to imply that the like objects so referred-to have to be in a corresponding order or sequence, either temporally, spatially, in ranking, or in any other manner.

Also for purposes of this description, the terms “couple,” “coupling,” “coupled,” “connect,” “connecting,” or “connected” refer to any manner known in the art or later developed in which energy is allowed to be transferred between two or more elements, and the interposition of one or more additional elements is contemplated, although not required. Conversely, the terms “directly coupled,” “directly connected,” etc., imply the absence of such additional elements. The same type of distinction applies to the use of terms “attached” and “directly attached,” as applied to a description of a physical structure. For example, a relatively thin layer of adhesive or other suitable binder can be used to implement such “direct attachment” of the two corresponding components in such physical structure.

As used herein in reference to an element and a standard, the terms “compatible” and “conform” mean that the element communicates with other elements in a manner wholly or partially specified by the standard, and would be recognized by other elements as sufficiently capable of communicating with the other elements in the manner specified by the standard. A compatible or conforming element does not need to operate internally in a manner specified by the standard.

The described embodiments are to be considered in all respects as only illustrative and not restrictive. In particular, the scope of the disclosure is indicated by the appended claims rather than by the description and figures herein. All changes that come within the meaning and range of equivalency of the claims are to be embraced within their scope.

The functions of the various elements shown in the figures, including any functional blocks labeled as “processors” and/or “controllers,” may be provided through the use of dedicated hardware as well as hardware capable of executing software in association with appropriate software. Upon being provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non-volatile storage. Other hardware, conventional and/or custom, may also be included. Similarly, any switches shown in the figures are conceptual only. Their function may be carried out through the operation of program logic, through dedicated logic, through the interaction of program control and dedicated logic, or even manually, the particular technique being selectable by the implementer as more specifically understood from the context.

It should be appreciated by those of ordinary skill in the art that any block diagrams herein represent conceptual views of illustrative circuitry embodying the principles of the disclosure. Similarly, it will be appreciated that any flow charts, flow diagrams, state transition diagrams, pseudo code, and the like represent various processes which may be substantially represented in computer readable medium and so executed by a computer or processor, whether or not such computer or processor is explicitly shown.

As will be appreciated by one of ordinary skill in the art, the present disclosure may be embodied as an apparatus (including, for example, a system, a network, a machine, a device, a computer program product, and/or the like), as a method (including, for example, a business process, a computer-implemented process, and/or the like), or as any combination of the foregoing. Accordingly, embodiments of the present disclosure may take the form of an entirely software-based embodiment (including firmware, resident software, micro-code, and the like), an entirely hardware embodiment, or an embodiment combining software and hardware aspects that may generally be referred to herein as a “system” or “network”.

Embodiments of the disclosure can be manifest in the form of methods and apparatuses for practicing those methods. Embodiments of the disclosure can also be manifest in the form of program code embodied in tangible media, such as magnetic recording media, optical recording media, solid state memory, floppy diskettes, CD-ROMs, hard drives, or any other non-transitory machine-readable storage medium, wherein, upon the program code being loaded into and executed by a machine, such as a computer, the machine becomes an apparatus for practicing the disclosure. Embodiments of the disclosure can also be manifest in the form of program code, for example, stored in a non-transitory machine-readable storage medium including being loaded into and/or executed by a machine, wherein, upon the program code being loaded into and executed by a machine, such as a computer, the machine becomes an apparatus for practicing the disclosure. Upon being implemented on a general-purpose processor, the program code segments combine with the processor to provide a unique device that operates analogously to specific logic circuits.

The term “non-transitory,” as used herein, is a limitation of the medium itself (i.e., tangible, not a signal) as opposed to a limitation on data storage persistency (e.g., RAM vs. ROM).

In this specification including any claims, the term “each” may be used to refer to one or more specified characteristics of a plurality of previously recited elements or steps. When used with the open-ended term “comprising,” the recitation of the term “each” does not exclude additional, unrecited elements or steps. Thus, it will be understood that an apparatus may have additional, unrecited elements and a method may have additional, unrecited steps, where the additional, unrecited elements or steps do not have the one or more specified characteristics.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements. For example, the phrases “at least one of A and B” and “at least one of A or B” are both to be interpreted to have the same meaning, encompassing the following three possibilities: 1—only A; 2—only B; 3—both A and B.

The embodiments covered by the claims in this application are limited to embodiments that (1) are enabled by this specification and (2) correspond to statutory subject matter. Non-enabled embodiments and embodiments that correspond to non-statutory subject matter are explicitly disclaimed even if they fall within the scope of the claims.

As used herein and in the claims, the term “provide” with respect to an apparatus or with respect to a system, device, or component encompasses designing or fabricating the apparatus, system, device, or component; causing the apparatus, system, device, or component to be designed or fabricated; and/or obtaining the apparatus, system, device, or component by purchase, lease, rental, or other contractual arrangement.

While preferred embodiments of the disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the technology of the disclosure. It is intended that the following claims define the scope of the invention and that methods and structures within the scope of these claims and their equivalents be covered thereby.

What is claimed is:

1. A home network operated by a home network operator, the home network comprising communication hardware and a processor configured to control the communication hardware such that:
the home network is configured to provide communication services to a wireless device;
the home network is configured to enable selective connection of the wireless device either (i) to a first visiting network operated by a first visiting network operator having a first service agreement with the home network operator or (ii) to a second visiting network operated by a second visiting network operator having a second service agreement with the home network operator; and
the home network is configured to (i) receive a first connection request from the first visiting network identifying the wireless device and a set of desired communication services, (ii) determine that the second visiting network and not the first visiting network is appropriate for the set of desired communication services for the wireless device, and (iii) transmit a negative connection response to the first visiting network.

2. The home network of claim 1, wherein the home network is configured to be programmed with a priority list in which the second visiting network is prioritized over the first visiting network for the set of desired communication devices.

3. The home network of claim 2, wherein the home network is configured to be programmed with the priority list in which the first visiting network is prioritized over the second visiting network for a different set of desired communication devices.

4. The home network of claim 1, wherein the home network is configured to transmit the negative connection response to the wireless device via the first visiting network denying the communication services provided to the wireless device.

5. The home network of claim 1, wherein the home network is configured to (i) receive a second connection request from the second visiting network identifying the wireless device and the set of desired communication services, (ii) determine that the second visiting network is appropriate for the set of desired communication services for the wireless device, and (iii) transmit a positive connection response to the second visiting network to allow the wireless device to connect to the second visiting network for the set of desired communication services.

6. The home network of claim 5, wherein the home network is configured to transmit the positive connection response to the wireless device via the second visiting network confirming the communication services provided to the wireless device.

7. The home network of claim 1, wherein the home network is configured to prioritize either the first visiting network or the second visiting network based on at least one of (a) the wireless device being a particular type of communication device and (b) a user of the wireless device having a particular type of subscription to the home network.

8. A method for a home network operated by a home network operator, the method comprising:
the home network being configured to provide communication services to a wireless device;
the home network being configured to enable selective connection of the wireless device either (i) to a first visiting network operated by a first visiting network operator having a first service agreement with the home network operator or (ii) to a second visiting network operated by a second visiting network operator having a second service agreement with the home network operator; and
the home network (i) receiving a first connection request from the first visiting network identifying the wireless device and a set of desired communication services, (ii) determining that the second visiting network and not the first visiting network is appropriate for the set of desired communication services for the wireless device, and (iii) transmitting a negative connection response to the first visiting network.

9. The method of claim 8, wherein the home network is programmed with a priority list in which the second visiting network is prioritized over the first visiting network for the set of desired communication devices.

10. The method of claim 9, wherein the home network is programmed with the priority list in which the first visiting network is prioritized over the second visiting network for a different set of desired communication devices.

11. The method of claim 8, wherein the home network transmits the negative connection response to the wireless device via the first visiting network denying the communication services provided to the wireless device.

12. The method of claim 8, wherein the home network (i) receives a second connection request from the second visiting network identifying the wireless device and the set of desired communication services, (ii) determines that the second visiting network is appropriate for the set of desired communication services for the wireless device, and (iii) transmits a positive connection response to the second visiting network to allow the wireless device to connect to the second visiting network for the set of desired communication services.

13. The method of claim 12, wherein the home network transmits the positive connection response to the wireless device via the second visiting network confirming the communication services provided to the wireless device.

14. The method of claim 8, wherein the home network prioritizes either the first visiting network or the second visiting network based on at least one of (a) the wireless device being a particular type of communication device and (b) a user of the wireless device having a particular type of subscription to the home network.
